(19) United States
(12) Patent Application Publication
(10) Pub. No.: US 2004/0249831 A1
(43) Pub. Date: Dec. 9, 2004

(54) Efficient similarity search and classification via rank aggregation

(76) Inventors: Ronald Fagin, Los Gatos, CA (US); Shanmugasundaram Ravikumar, San Jose, CA (US); Dandapani Sivakumar, Cupertino, CA (US)

Correspondence Address: MARK D. MCSWAIN, IBM ALMADEN RESEARCH CENTER, IP LAW DEPT., 650 HARRY ROAD, CHTA/J2B, SAN JOSE, CA, 95120, US

(21) Appl. No.: 10/458,512

(22) Filed: Jun. 9, 2003

(51) Int. Cl. G06F 17/00

(52) U.S. Cl. 707/100

(57) ABSTRACT

A system, method, and computer program product for automatically performing similarity search, classification, and other nearest-neighbor search-based applications using rank aggregation. The invention reduces the ε-approximate Euclidean nearest neighbor problem to the problem of finding the candidate with the best median rank in an election with n candidates and O(ε⁻²logn) voters.

Database elements and a query are points projected in a multidimensional Euclidean space, and coordinates in the space serve as independent “voters” that rank database elements by their closeness to the query coordinate. The rankings are aggregated and the winners are the database elements with the highest aggregated ranks.

Combined with dimensionality reduction, the invention is a simple, efficient, database-friendly scheme for generating a ε-approximate nearest neighbor answer.

The invention also enables searching of categorical vs. mere numerical features by sorting the database according to each feature and aggregating the resulting rankings.

### FIELD OF THE INVENTION

This invention relates to automatically determining in a computationally efficient manner which objects in a collection best match specified target attribute criteria. Specifically, the invention performs approximate nearest neighbor analysis by performing a combination of dimensionality reduction and rank aggregation.

### DESCRIPTION OF RELATED ART

A copy of a SIGMOD article “Efficient Similarity Search and Classification Via Rank Aggregation” to be published on Jun. 9, 2003 is attached and serves as an Appendix to this application. The following prior art articles are hereby incorporated by reference:

Commonly-owned co-pending U.S. patent application U.S. Ser. No. 10/153,448, “Optimal Approximate Approach to Aggregating Information”, filed May 21, 2002.

R. Fagin, A. Lotem, M. Naor. Optimal Aggregation Algorithms for Middleware, in Proceedings of the Twentieth ACM SIGMOD-SIGACT-SIGART Symposium on Principles of Database Systems (PODS '01), Santa Barbara, Calif., p. 102-113, 2001, available online at doi.acm.org/10.1145/375551.375567, full paper available online at www.almaden.ibm.com/cs/people/fagin/pods01rj.pdf referred to hereafter as [Fagin].

J. Kleinberg. Two Algorithms for Nearest-Neighbor Search in High Dimensions, in Proceedings of the 27^{th} Annual ACM Symposium on Theory of Computing, 30(2):451-474, 2000 referred to hereafter as [Kleinberg].

C. Dwork, R. Kumar, M. Naor, and D. Sivakumar. Rank Aggregation Methods for the Web, in Proceedings of the 10^{th} International World Wide Web Conference, p. 613-622, 2001 referred to hereafter as [Dwork].

### BACKGROUND OF THE INVENTION

Rank Aggregation

Today's data retrieval systems often employ data repositories that are attached to the internet, and search engines that help users find desired data. Search engines typically generate a list of documents (or, more often, a list of URLs where documents may be directly accessed) that are somehow deemed to be the most relevant to the user's query. The documents usually include search terms specified by a user, but the precise scheme that a particular search engine uses to determine document relevance is often hidden from view.

Objects in a database each have a number of attributes, and each attribute of an object may be assigned a grade describing the degree to which that object meets an attribute description. A database of N objects each having m attributes can therefore be thought of as a set of m sorted lists, L₁, . . . , Lₘ, each of length N, and each sorted by attribute grade (e.g. highest grade first, with ties broken arbitrarily). A search engine's answer to a query can be thought of as a single sorted list, with the answers having been sorted by a decreasing relevance score or grade based on a number of attributes involved in the query.

One approach to dealing with such graded data is to use an aggregation function t that combines individual grades to obtain an overall grade. Users are often interested in finding the set of k objects in a database that have the highest overall grade according to a particular query, and sometimes in seeing the overall grades. In this description, k is a constant, such as k=1 or k=10, and algorithms are considered for obtaining the top k answers in databases containing at least k objects. There are many different aggregation functions used for various purposes.

There is an obvious naive algorithm for obtaining the top k answers: simply look at every entry in each of the m sorted lists, compute the overall grade of every object using the aggregation function t, and return the top k answers. Unfortunately, the naive algorithm has a high computational cost and thus is often not feasible for a large database. Middleware cost is determined by the computational penalties imposed by two modes of accessing data. The first mode of access is sorted (or sequential) access, where the middleware system obtains the grade of an object in one of the sorted lists by proceeding through the list sequentially from the top. The second mode of access is random access, where the middleware system requests the grade of a particular object in a particular list, and obtains it in one step. In some cases, random access may be expensive relative to sorted access, or entirely impossible.

An algorithm referred to as “Fagin's algorithm” was described in R. Fagin, Combining Fuzzy Information from Multiple Systems, in Proceedings of the Fifteenth ACM SIGMOD-SIGACT-SIGART Symposium on Principles of Database Systems (PODS'96), p. 216-226, 1996. This algorithm often performs much better than the naive algorithm. Another algorithm, termed the “threshold algorithm” was first published in S. Nepal and M. V. Ramakrishna, Query Processing Issues in Image (Multimedia) Databases, in Proc. 15^{th} International Conference on Data Engineering (ICDE), March 1999, p. 22-29. These algorithms each find the top k answers for monotone aggregation functions, at various computational costs and with buffers of various size.

There are times when the user may be satisfied with an approximate top k list, instead of an exact top k list that incurs a heavier computational penalty. An efficient method of finding an approximate top k list, and an estimate of how close that approximate list is to the exact list, is desirable. Similarly, a method of finding a top k list that factors in the relative computational costs of sorted access and random access is also desirable. Fortunately, such methods are described in the “Optimal Approximate Approach to Aggregating Information” patent application and the [Fagin] reference cited above. In these references, the threshold algorithm is modified to turn it into an approximation algorithm termed “threshold algorithm-theta” or TA-θ. For instances where random accesses are impossible, an algorithm termed NRA (“No Random Accesses”) is employed.

In NRA, only the top k objects, without their associated grades, are generated, since it may be much cheaper in terms of sorted accesses to find the top k answers without their grades. Sometimes enough partial information can be obtained about grades to know that an object is in the top k objects without knowing its exact grade. Further, the top k objects are generated, but no information about the sorted order (i.e. sorted by grade) is produced. The sorted order can be easily determined afterwards, by finding the top object, the top 2 objects, etc. NRA defines functions that are lower and upper bounds on the value the aggregation function can obtain, and then proceeds until there are no more candidates whose current upper bound is better than the current k^{th} largest lower bound.

Nearest Neighbor Searching

The nearest neighbor problem is ubiquitous in many applied areas of computer science. Informally, the problem is: given a database D of n points in some metric space, and given a query q in the same space, find the point in D closest to q. Some prominent applications of nearest neighbor solutions include similarity search for information retrieval and pattern classification, for example in optical character recognition. The popularity of research on the nearest neighbor problem is due to the fact that it is often quite easy and natural to map the features of real-life objects into vectors in a metric space, and under this formulation, problems like similarity searching and classification become nearest neighbor problems. Since the mapping of objects into feature vectors is often a heuristic step, in many applications it suffices to find a point in the database that is only approximately the nearest neighbor. Even the more sophisticated algorithms typically achieve a query time that is logarithmic in the number of database elements and exponentially dependent on the number of dimensions in the space.

A method for performing efficient similarity search and classification in high dimensional data that combines the computationally desirable aspects of both nearest neighbor searching and rank aggregation is needed.

### SUMMARY OF THE INVENTION

It is accordingly an object of this invention to provide a system, method, and computer program product for automatically performing similarity search, classification, and other nearest-neighbor search-based applications in high dimensional data using rank aggregation and instance-optimal algorithms. The invention determines which objects in a collection best match specified target attribute criteria, i.e. the general goal is to find candidate database elements that are similar to a query.

The invention reduces the ε-approximate Euclidean nearest neighbor problem to the problem of finding the candidate with the best median rank in an election with n candidates and a number of voters, where ε is the degree of acceptable approximation to a nearest neighbor solution.

In a preferred embodiment, n database elements and a user query q are treated as points in a multidimensional Euclidean space. Sorting of the database elements along d coordinates is the only required pre-processing. The number coordinates may be equal to n, or may be reduced, preferably to m=O(ε\hat{ }−2 log n). Each coordinate in the space serves as an independent “voter” that ranks the database elements based on their similarity to the query, which is defined as the closeness to the coordinate corresponding to the query. Each voter may project all the vectors from an origin to the query and database element points onto a random line unique to each voter, and rank the database elements based on the proximity of the projections to the projection of the query.

The resulting ranked candidate listings are then combined by a highly efficient instance-optimal aggregation algorithm, that accesses the ranked lists from the voters, one element of every list at a time, until some candidate is seen in more than a specified percentile of the lists. The winners are those database element points having the highest aggregated ranks. The aggregated rank may be the best median (i.e. 50^{th} percentile) rank, for example, though other percentile ranks may be employed; the percentile specified is a strict lower bound on the number of ranked lists an element has to appear in before it is declared the winner. The top k winners are returned, where k is a predetermined number.

The ranked lists need not be read in their entirety; the invention often obtains very high quality results after exploring no more than 5% of the data. The invention is also database-friendly in that it accesses data primarily in a pre-defined order without random accesses, thus avoiding the need for indices for locating the value of a coordinate of an element. The invention requires almost no extra storage.

The invention enables processing of catalog searches, i.e. by categorical vs. merely numerical features, by sorting the database according to each feature and aggregating the rankings produced.

The foregoing objects are believed to be satisfied by the embodiments of the present invention as described below.

### BRIEF DESCRIPTION OF THE DRAWINGS

FIG. 1 is a pseudocode description of the MEDRANK algorithm.

FIG. 2 is a pseudocode description of the OMEDRANK algorithm.

FIG. 3 is a pseudocode description of the L2TA algorithm.

### DETAILED DESCRIPTION OF THE INVENTION

Suppose we are conducting nearest neighbor searches with a database D of n points in the d-dimensional space X^{d} (where X is the underlying set—reals, {0, 1}, etc.), and are given a query q∈X^{d}. We may consider each coordinate of the d-dimensional space as a “voter,” and the n database points as “candidates” in an election process. Voter j, for 1≦j≦d, ranks all the n candidates based on how close they are to the query in the j-th coordinate. This leaves us with d ranked lists of the candidates, and our goal is to synthesize from these a single ordering of the candidates; we are typically interested in the top few candidates in this aggregate ordering.

How do we aggregate the d ranked lists produced by the d coordinates? This is precisely the rank aggregation problem. The history of this problem goes back at least two centuries, but its mathematical understanding took place in the last sixty years, and the underlying computational problems are still within the purview of active research. The most important mathematical questions on rank aggregation are concerned with identifying robust mechanisms for aggregation. Particularly noteworthy achievements in this field are the works of Young (H. P. Young, Condorcet's theory of voting, American Political Science Review, 82:1231-1244, 1988) and Young and Levenglick (H. P. Young and A. Levenglick, A consistent extension of Condorcet's election principle, SIAM Journal on Applied Mathematics, 35(2):285-300, 1978), who showed that a proposal of Kemeny (J. G. Kemeny, Mathematics without numbers, Daedalus, 88:571-591, 1959) leads to an aggregation mechanism that possesses many desirable properties. For example, it satisfies the Condorcet criterion, which says that if there is a candidate c such that for every other candidate c′, a majority of the voters prefers c to c′, then c should be the winner of the election. Aggregation mechanisms that satisfy the Condorcet criterion and its natural extensions are considered to yield robust results that cannot be “spammed” by a few bad voters [Dwork].

Kemeny's proposal is the following: given d permutations τ¹, τ², . . . τ^{d} of n candidates, produce the permutation σ that minimizes

$${\sum }_{i = 1}^{d} K ( {τ}_{i} , σ )$$

where K(τ, σ) denotes the Kendall tau distance, that is, the number of pairs (c,c′) of candidates on which the rankings τ and σ disagree (one of them ranks c ahead of c′, while the other ranks c′ ahead of c). Unfortunately, computing a Kendall-optimal aggregation of even 4 lists is NP-complete [Dwork], so one has to resort to approximation algorithms and heuristics.

We now explicate the connection between nearest neighbors and rank aggregation. As a simple but powerful motivating example, note that if the underlying space is {0, 1}^{d} endowed with the Hamming metric, then each voter really produces a partial order; given a query q, the i-th voter partitions the database D into two sets Dᵢ⁺={x∈D|xᵢ=qᵢ} and Dᵢ⁻={x∈D|xᵢ≠qᵢ}, ranking all of Dᵢ⁻ ahead of Dᵢ³¹ . (The notions of Kendall tau distance and Kemeny optimal aggregation still remain meaningful, since they are based on comparing two candidates at a time.) It is not hard to see that in this case, the Kemeny optimal aggregation of the partial orders produced by the voters precisely sorts the points in the database in order of their (Hamming) distance to the query vector q. Considering also the fact that the nearest neighbor problems in several interesting metrics can be reduced to the case of the Hamming metric, we note that the rank aggregation viewpoint is, in general, at least as powerful as nearest neighbors. (We will provide even more compelling evidence shortly.)

On the other hand, we have taken a problem (the nearest neighbor problem) that can be solved by a straightforward algorithm in O(nd) time and recast it as an NP-complete problem. Even some of the good approximation algorithms and heuristics for the aggregation problem (e.g., see [Dwork]) take time at least Ω(nd+n²).

However, note that we are really interested in the top few elements in the aggregate list, and not necessarily in completely ordering the points in the database according to their distance to the query. Thus it suffices if we are able to determine the winner (or a few winners) in the aggregation. However, even determining the Kemeny optimal winner is a hard computational problem, so we have to resort to approximation algorithms and heuristics. Specifically, an ordering that is optimal in the footrule sense is guaranteed to be a factor-2 approximation to a Kemeny optimal ordering. Moreover, footrule-optimal aggregation has the following nice heuristic. Sort all the points in the database based on the median of the ranks they receive from the d voters. The reason this is a reasonable heuristic is that if the median ranks are all distinct, then this procedure actually produces a footrule optimal aggregation. Thus, we have reduced our problem (heuristically) to that of finding the database point with the best median rank (or the points with the top few median ranks).

We would like to propose a method that has properties desirable in a database system. Specifically, suppose it is desired to support nearest neighbor queries (or approximate nearest neighbor queries) in a database system. Ideally, one would like to avoid methods that involve complex data structures, large storage requirements, or that make a large number of random accesses. These considerations immediately rule out some of the theoretically provably good methods, and also encumber many of the methods from the recent database literature.

Our method uses sorting as the only pre-processing step, needs virtually no additional storage, and performs virtually no random accesses. (It is traditional not to charge nearest-neighbor algorithms for pre-processing steps, where data structures are set up. The idea is that many queries will be asked, and the cost of the data structures is amortized over these queries.) By avoiding random accesses, our method does not need indices that can locate the value of a coordinate of an element.

We now make a crucial observation that addresses both concerns—efficiency and database friendliness of the rank aggregation approach to similarity search and classification.

In the idea outlined above, suppose that we had pre-sorted the n database points along each of the d coordinates. Given a query q=(qᵢ, . . . , q_{d}), we could easily locate the value qᵢ, for 1≦i≦d in the i-th sorted list, and place two “cursors” in this location. Once the 2d cursors have been placed, two for each i, by moving one cursor “up” and one cursor “down,” we can now produce a stream that produces the ranked list of the i-th voter, one element at a time, and on demand. That is, we can now think of the d voters as operating in the following online fashion: the first time the i-th voter is called, it will return the database element closest to q in coordinate i, the second time it will return the second closest element in coordinate i, and so on. Thus, effectively, we have an online version of the aggregation problem to solve.

The fact that we can easily produce online access to the d voters (with calls of the form “return the next most highly ranked element”), together with the fact that we would like to produce the candidate with the best median rank, suggests that it might be possible to identify this winner without even having to read the ranked lists in their entirety. Indeed, computing aggregations of score lists using an “optimal” number of sequential and random accesses to the lists—and hopefully without having to consult the lists completely—has attracted much work in recent database literature. We will design an algorithm in the spirit of the NRA, or “no random access,” algorithm from [Fagin]. This method, applied to the online median-rank-winner problem, yields an exceedingly crisp algorithm that can be summarized in one sentence: Access the ranked lists from the d voters, one element of every list at a time, until some candidate is seen in more than half the lists—this is the winner. We will call this algorithm the MEDRANK algorithm. We will show that MEDRANK is not just a good algorithm, but up to a constant multiple, it is the best possible algorithm on every instance, among the class of algorithms that access the ranked lists in sequential order. In fact, even if we allow both sequential and arbitrary random accesses, the algorithm takes time that is within a constant factor of the best possible on every instance. This notion is called instance optimality in [Fagin].

Algorithm MEDRANK has excellent properties in terms of being suitable for database applications; however, it is only a heuristic solution to the rank aggregation problem (especially if we are interested in Kendall-optimal winners). To remedy this unsatisfactory state of affairs, we employ another powerful idea that has often been considered in the nearest neighbor literature, since the pioneering work of Kleinberg. The idea is that of projections along random lines in the d-dimensional space. Specifically, using a simple geometric lemma first noted in [Kleinberg], that if we project the n database points (as well as the query point) into m dimensions, where m=O(ε⁻²logn), and then run MEDRANK on the projected data, then with high probability, the winner according to the MEDRANK algorithm is an ε-approximate nearest neighbor under the Euclidean metric. (We say that c is an ε-approximate nearest neighbor of q if, for every c′ ∈D, we have d(c, q)≦(1+ε)d(c, q), where d denotes the Euclidean distance metric.)

Hitherto, we have argued that with the right choices of pre-processing steps and aggregation algorithms, the rank aggregation paradigm leads to methods for similarity search and classification that have two desirable properties: robustness of results (provably as powerful as nearest neighbors, Condorcet criterion, etc.) and efficiency of implementation (simple sequential accesses suffice). We now point out another very useful feature of this method in the context of databases.

Consider a similarity search problem where the objects do not naturally fit in any natural metric space, such as a catalog of electronic appliances, where the “features” are categorical rather than numerical. In these situations, comparing the feature types amounts to comparing apples and oranges: it is extremely artificial—and questionable—to model the objects as points in a metric space where all coordinates have the same semantics. In these situations, the rank aggregation paradigm fits in naturally: when looking for objects similar to a query object, simply sort the database according to each feature, and aggregate the rankings produced. Catalog searches are very common database operations, and our MEDRANK algorithm suitably implemented, should result in an efficient and effective solution to this problem.

Framework and Algorithms

We now describe the framework, including necessary preliminaries about rank aggregation and about instance optimal algorithms. There are two main technical results in this part: (1) a reduction from the ε-approximate Euclidean nearest neighbor problem to the problem of finding the candidate with the best median rank in an election with n candidates and O(ε⁻² log n) voters; and (2) a proof that our MEDRANK algorithm which only makes sequential accesses to the d ranked lists, makes at most a constant factor more accesses than any algorithm that uses sequential and random accesses to the lists, for every database and query. Thus MEDRANK is instance optimal in the database model for computing the median winner, and also yields a provably approximate nearest neighbor.

Rank Aggregation, Nearest Neighbors, and Instance Optimal Algorithms

Let σ and τ denote permutations on n objects; by τ(i), we will mean the rank of object i under the order σ (lower values of the rank are “better”). Often we will say that i is ranked “ahead of” or “better than” or “above” j by σ if σ(i)<σ(j). The Kendall tau distance between σ and τ, denoted by K(σ, τ), is defined to be the number of pairs (i, j) such that either σ(i)>σ(j) but τ(i)<τ(j) or σ(i)<σ(j) but τ(i)>τ(j). The footrule distance between σ and τ, denoted by F (σ, τ), is defined to be

$${\sum }_{i} \vert σ ( i ) - τ ( i ) \vert .$$

Let τ₁, τ₂, . . . , τₘ denote m permutations of n objects. A Kendall-optimal aggregation of τ₁, . . . , τₘ is any permutation a such that

$${\sum }_{i} K ( σ , {τ}_{i} )$$

is minimized; similarly, a footrule-optimal aggregation of τ₁, . . . , τₘ is any permutation a such that

$${\sum }_{i} F ( σ , {τ}_{i} )$$

is minimized. It is known (from P. Diaconis and R. Graham, Spearman's Footrule as a Measure of Disarray, Journal of the Royal Statistical Society, Series B, 39(2):262-268, 1977) that F(σ, τ)<K(σ, τ)≦2K(σ,τ). It follows that if a is a footrule-optimal aggregation of τ₁, . . . , τₘ, then the total Kendall distance of a from τ₁, . . . , τₘ namely,

$${\sum }_{i} K ( σ , {τ}_{i} )$$

is within a factor of two of the total Kendall distance of the Kendall-optimal aggregation from τ₁, . . . , τₘ. Furthermore, although computing a Kendall-optimal aggregation is NP-hard, computing footrule-optimal aggregations can be done in polynomial time via minimum-cost perfect matching [Dwork]. In fact, the following proposition pointed out in [Dwork] (and whose proof is quite easy) shows that in many cases, there is a very simple heuristic for footrule-optimal aggregation.

Proposition 1. Let τ₁, τ₂, . . . , τₘ denote m permutations of n objects. For each c with 1≦c≦n, define medrank(c)=median(r_{c}ⁱ, . . . , r^{m}), where r_{c}¹=τᵢ(c). If the set of median values {medrank(c)1≦c≦n} contains all distinct n values, then the permutation medrank is a footrule-optimal aggregation of τ₁, . . . , τₘ.

Let D be a database of n points in R^{d}. For a vector q∈R^{d}, a Euclidean nearest neighbor of q in D is any point x∈D such that for all y∈D, we have d(x, q)≦d(y, q), where d denotes the usual Euclidean distance. For a vector q∈R^{d} and ε>0, an ε-approximate Euclidean nearest neighbor of q in D is any point X∈D such that for all y∈D, we have d(x, q)≦(1+ε) d(y, q), where d denotes the usual Euclidean distance.

An Algorithm for Near Neighbors

The idea of projecting the data along randomly chosen lines in R^{d} was introduced in the context of nearest neighbor search by Kleinberg. Specifically, consider a point q ∈ R^{d}, and let u, v ∈ R^{d} be such that d(v, q)>(1+ε) d(u, q). Suppose we pick a random unit vector r in d dimensions; an efficient way to do this is to pick the d coordinates r₁, . . . r_{d} as independent and identically distributed random variables distributed according to the standard normal distribution N(0, 1), and normalize the vector to have unit length. We then project u, v, and q along r. Then intuitively we expect the projection of u to be somewhat closer to the projection of q than the projection of v is. The following lemma is a formal statement of this fact; here <.,.> denotes the usual inner product.

Lemma 2 (from [Kleinberg]). Assume x, y ∈ R_{d}, and let ε>0 be such that ∥y∥²>(1+ε)∥x∥². if r is a random unit vector in R^{d} (chosen as described above), then Pr[<y, r>≦<x, r>]≦1/2−ε/3.

By applying the lemma to u-q and v-q, we have that <u, r> is closer to <q, r> than <v, r> is to <q, r> with probability at least 1/2+ε/3.

Now let q be a query point, let w∈D be the closest point to q, and let B={x∈D|d(x, q)>(1+ε) d(w, q)}. Consider a fixed x∈B. If we pick a random vector r and rank the points in D according to their distances from the projection of q along r, then w is ranked ahead of x with probability at least 1/2+ε/3. Suppose we pick several random vectors r₁, . . . , rₘ and create m ranked lists of the points in D by projecting along each of the m random lines. Then the expected number of lists in which w is ranked ahead of x is at least m(1/2+ε/3); indeed, by standard Chemoff bounds, if m=αε⁻²logn with α suitably chosen, then w is ranked ahead of x in more than m(1/2+ε/6) of the lists with probability at least 1−1/n². Summing up the error probability over all x∈B, we see that this implies that w is ranked ahead of every x∈B with probability at least 1−1/n. In particular, with probability at least 1−1/n, for every x∈B, the median rank of w in the m lists is better than the median rank of x in the m lists. Therefore, if we compute the point in D that has the best median rank among the m lists, then (with probability at least 1−1/n), this point cannot be an element of B, so it must be some element z such that d(z, q)<(1+ε) d(w, q). By using a VC dimension argument similar to [Kleinberg], we can, in fact, show that with probability at least 1−1/n, the chosen random vectors are “good” in this sense for every query q. We summarize this argument in the form of a theorem.

Theorem 3. Let D be a collection of n points in R^{d}. Let r₁, . . . , rₘ be random unit vectors in R^{d}, where m=αε⁻²logn with α suitably chosen. Then with probability at least 1−1/n, the following statement holds. Let q∈R^{d} be an arbitrary point, and define, for each i with 1<i<m the ranked list Lᵢ of the n points in D by sorting them in increasing order of their distance to the projection of q along rᵢ. For each element x of D, let medrank(x)=median(L₁(x), . . . , Lₘ(x)). Let z be a member of D such that medrank(z) is minimized. Then d(z, q)≦(1+ε) d(x, q) for all X∈D.

In fact, the above argument shows more. Let q be a query, and let w∈D be the closest point to it. If we partition the database D into the disjoint subsets B₀, B₁, . . . , where Bₜ consists of all points of distance at most (1+ε)^{t} times d(w, q), then with high probability, for every t, every point of Bₜ has a better median rank than every point of Bₜ₊₁. Let us say that this event happens, that is, that every point of Bₜ has a better median rank than every point of Bₜ₊₁. In particular, for every c∈B^{t} and c′∈B^{t+1}, the majority of voters prefers c to c′. This is an instance of the extended Condorcet criterion, which is one of the many nice features of Kendall-optimal aggregation. The extended Condorcet criterion says that if there are subsets S, T of the candidates such that for every c∈S and c′∈T, a majority of the voters prefer c to c′, then every candidate in S should be ranked ahead of every candidate in T. Therefore, every aggregation algorithm that satisfies the extended Condorcet criterion (not just sorting by median rank) must rank every point of Bₜ ahead of every point of Bₜ₊₁.

For the purposes of implementation, we of course cannot sort the n points of the database m times for each query q. Rather, as part of the pre-processing, we create m sorted lists of the n points in D. The i-th sorted list sorts the points based on the values of their projections along the i-th random vector rᵢ. The i-th sorted list is of the form (cⁱ₁, vⁱ₁), (cⁱ₂, vⁱ₂), . . . , (cⁱₙvⁱₙ), where (1) vⁱₜ=<cⁱₜ, rᵢ> for each t, (2) vⁱ₁≦vⁱ₂≦ . . . vⁱₙ, and (3) cⁱ₁, . . . , cⁱₙ is a permutation of {1, . . n}. Given a query q∈R^{d}, we first compute the projection of q along each of the m random vectors. For each i, we locate <rᵢ, q> in the i-th sorted list, that is, find t such that vⁱₜ≦<rᵢ, q>≦vⁱₜ₊₁, and initialize two cursors to v¹ₜ and vⁱₜ₊₁. One of points cⁱₜ and cⁱₜ₊₁ is now the database point whose projection is closest to the projection of q. By suitably moving one of the two cursors “up” or “down,” we can implicitly create a list in which the database points are sorted in increasing order of the distance of their projections to q. This results in the following form of sequential access to the m lists: there is a routine initcursors(q) that takes a query q∈R^{d} and initializes the 2m cursors, and there is a routine getnext(i) that returns the next element in the i-th list (in order of proximity to the projection of q along rᵢ).

At the cost of more storage and pre-processing, we could also implement random access to the sorted lists with indices. Then, given a point x∈D, the routine getrank(x, i) would return the rank of the point x in the i-th sorted list. Our algorithm MEDRANK does not need such random access.

Instance Optimal Aggregation

We have now reduced the problem of computing an ε-approximate nearest neighbor to the scenario of [Fagin], which we now outline. There are m sorted lists, each of length n (there is one entry in each list for each of the n objects). Each entry of the i-th list is of the form (x, vᵢ), where vᵢ is the i-th “grade” of x. The i-th list is sorted in descending order by the vᵢ value. In our case, vᵢ is simply the rank of object x in the i-th list (ties are broken arbitrarily).

There are two modes of access to data, namely sorted (or sequential) access and random access. Under sorted access, the aggregation algorithm obtains the grade of an object in one of the sorted lists by proceeding through the list sequentially from the top. Thus, if object x has the l-th highest grade in the i-th list, then l sorted accesses to the i-th list are required to see this rank under sorted access. The second mode of access is random access. Here, the aggregation algorithm requests the grade of object x in the i-th list, and obtains it in one random access.

In this scenario, our algorithm MEDRANK can be described as follows. The value vᵢ for object x is the rank of object x in the i-th list. The algorithm MEDRANK does sorted access to each list in parallel. The first object that it encounters in more than half the lists is remembered as the top object (ties are broken arbitrarily). The next object that it encounters in more than half the lists is remembered as the number 2 object, and so on until the top k objects have been determined, at which time MEDRANK outputs the top k objects. Note that there are no random accesses. In fact, when the aggregation function is the median rank, it is easy to see that this algorithm is essentially the NRA (“No Random Access”) algorithm of [Fagin].

We shall show that in this scenario, algorithm MEDRANK is instance optimal [Fagin], which intuitively corresponds to being optimal (up to a constant multiple) for every database. More formally, instance optimality is defined as follows. Let A be a class of algorithms, let D be a class of databases, and let cost(A, D) be the total number of accesses (sorted and random) incurred by running algorithm A over database D. (In [Fagin], the cost of sorted and random accesses may be different. Taking the cost of all accesses to be the same, as we do here, affects the total cost by at most a constant multiple.) An algorithm B is instance optimal over A and D if B∈A and if for every A∈A and every D∈D we have

cost(B, D)=O(cost(A, D)). (Equation 1)

Equation (1) means that there are constants g and g′ such that cost(B, D)≦g cost(A, D)+g′ for every choice of A∈A and D∈D. The constant g is referred to as the optimality ratio. In our case, D is the class of all databases consisting of m sorted lists, where the score of an object in each list is its rank in that list, and A is the class of all correct algorithms (that find the top k answers for the median rank) under our scenario (where only sorted and random accesses are allowed).

Theorem 4. Let A and D be as above. Then algorithm MEDRANK is instance optimal over A and D.

Proof. Assume D∈D. Assume that the algorithm MEDRANK when run on D, halts and gives its output just after it has done l sorted accesses to each list. Hence, the k-th lowest median rank is l.

Let A be an arbitrary member of A. Let us define a vacancy in the i-th list to be an integer j such that the object at level j in the i-th list was not accessed by algorithm A under either sorted or random access in the i-th list. Let U be the set of lists that have a vacancy at a level less than l. We now show that the size of U is at most └m/2┘. Assume not. Define D′ to be obtained from D by modifying each list in U as follows. Let x be a new object, not in the database D. For each list in U, the rank of x in that list is taken to be the level of the first vacancy in that list, and whatever object was in this position in that list in D is moved to the bottom of that list. Object x is placed at the bottom of each list not in U. Intuitively, x fills the first vacancy in each list in U. Since the rank of x is less than l for more than half the lists, its median rank is strictly less than l. Now algorithm A performs exactly the same on D and D′, and so must have the same output. Therefore, algorithm A makes a mistake on D′, since x is not in the top k list that A outputs, even though x has a median rank less than the median rank (l) of some member of the top k list that A outputs. This is a contradiction, since by assumption A is a correct algorithm. So indeed, the size of U is at most └m/2┘.

Let Q be the number of accesses by A. From what we just showed, it follows that at least └m/2┘ lists have no vacancy at a level less than l. This implies

Q≦┌m/2┐(l−1)≦(m/2)(l−1).

Therefore, ml≦2Q+m. But ml is the number of accesses performed by MEDRANK. Hence, MEDRANK is instance optimal, with optimality ratio at most 2.

There are situations where algorithm MEDRANK probes the sorted lists until very near the end, but when the sorted lists are correlated, we expect it to terminate much earlier. It is shown in R. Fagin, Combining Fuzzy Information From Multiple Systems, J. Comput. Syst. Sci., 58:83-99, 1999, that even in the extremely pessimistic case where the lists are independently drawn at random, the expected probe depth of MEDRANK is roughly O(n^{1-2/m}). When the rank lists are produced by computing proximity of the random projections of the database points to the corresponding projections of the query, it can be shown that the lists are significantly more correlated.

### Summary of Algorithms

In this section, we present formal sketches of algorithm MEDRANK and also of two related algorithms, OMEDRANK and L2TA. Algorithm OMEDRANK is a heuristic improvement aimed at (further) improving its running time, and algorithm L2TA is an implementation of the “Threshold Algorithm” of [Fagin], an instance optimal algorithm for computing Euclidean nearest neighbors in the model where data in each coordinate is accessed via sequential and random accesses.

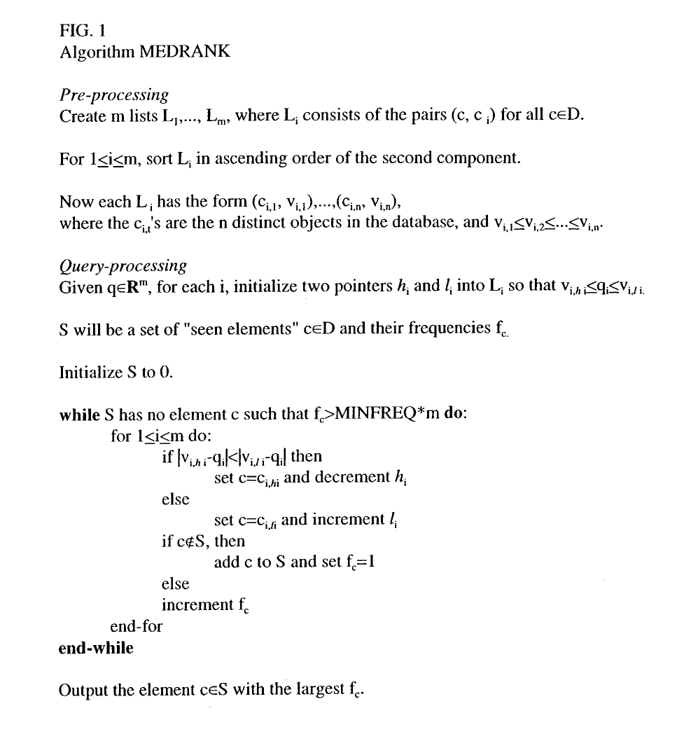

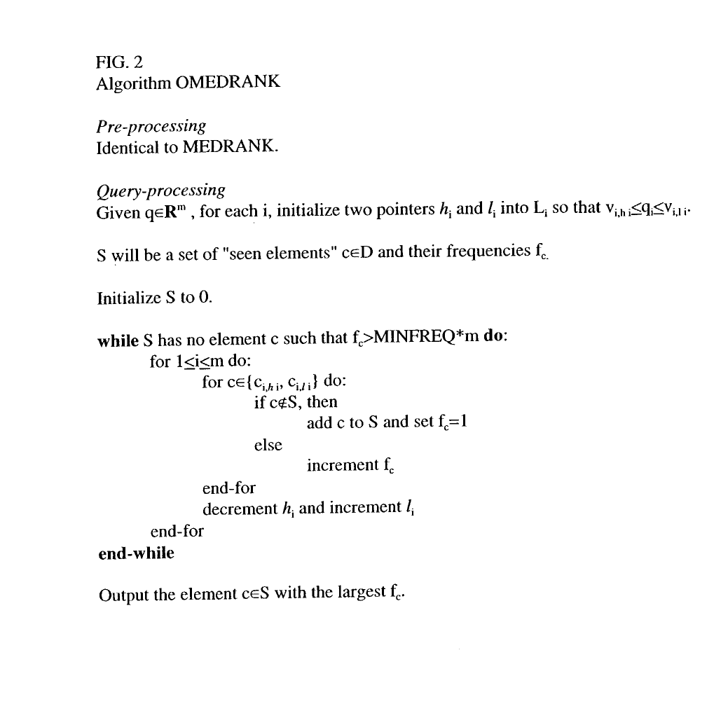

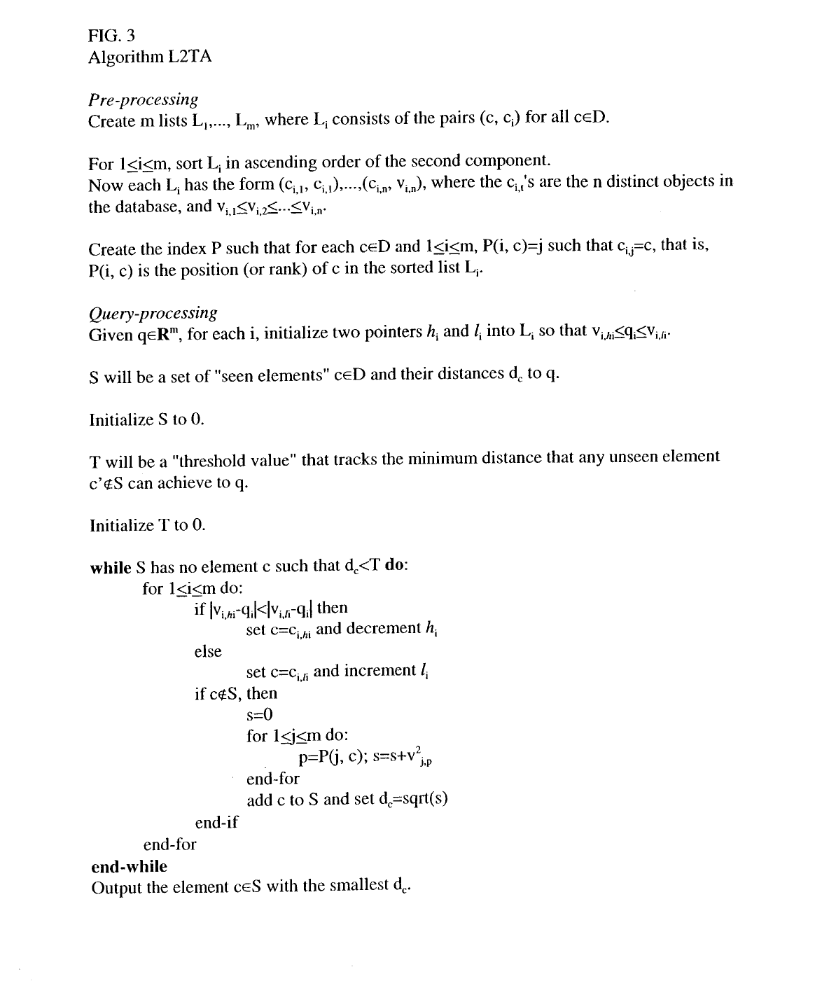

The descriptions are in the usual “pseudo-code” style in FIGS. 1, 2, and 3. Also, we will describe the procedures to find the winner; the extensions to finding the top k elements are fairly straightforward.

We will assume that we have a database D of n points in R^{m}, where m=d (the original Euclidean space) or m=O(ε⁻² log n) (the space after projecting all data along m random lines). For c∈D and 1≦i≦m, we will write cᵢ to denote the value of c in the i-th coordinate.

Algorithm MEDRANK is one among a family of aggregation algorithms, where we could strengthen the notion of median by taking quantiles other than the 50th percentile. We introduce the parameter MINFREQ in MEDRANK to vary this value to the other quantiles. Even though the algorithms with other values of MINFREQ do not ostensibly have any connection to nearest neighbors, we expect them to be excellent aggregation algorithms as well. The MINFREQ parameter is a strict lower bound on the number of lists an element has to appear in before it is declared the winner. Taking the median rank corresponds to setting MINFREQ=0.5.

The second algorithm we describe, OMEDRANK, is motivated by the following observation about MEDRANK. Instead of comparing the values v_{i,hi} and v_{i,li} and choosing the one closer to qᵢ, we will consider both elements c_{i,hi} and c_{i,li}. Since we do not perform any random accesses (of the form “find the rank of c_{i,hi} in some other list Lⱼ”), this will increase the number of elements we consider for membership in S. The advantage is that we avoid many comparisons.

Finally, we describe an instance optimal algorithm for computing Euclidean nearest neighbors; this algorithm is an application of the “threshold algorithm,” of [Fagin] to the problem of computing Euclidean (or L2) nearest neighbors. This algorithm, which we will call L2TA, can be used in place of the naive nearest neighbors algorithm.

Experimental Results

Speed

We studied the basic running time of the algorithm to compute the top 10 results. The running time includes query-specific preprocessing (like initialization and the setting up of cursors in L2TA, MEDRANK, and OMEDRANK). Since an actual nearest neighbor solution (found by a routine termed L2NN) on the full dimensional test data can be considered a reasonable approximation to the “absolute truth,” we compare the running time of each algorithm relative to the running time of L2NN on the full dimensional data.

The running times of MEDRANK and OMEDRANK are substantially smaller than that of L2NN on full dimensional test data (roughly only 35-45% of the time taken by L2NN). On projected data, MEDRANK and OMEDRANK are faster by two orders of magnitude. These algorithms remain much faster than L2NN even at very high values of MINFREQ. We remark that this difference will be even more pronounced were the data accessed from disk. Moreover, if we had counted the running time as the time to compute the top result (instead of the top 10 as we do now), MEDRANK and OMEDRANK would have performed even more dramatically.

Algorithm L2TA offers a significant speed up at low dimensions for some test data, but is poorer at high dimensions, and consistently worse than L2NN for other test data. This can be attributed to the bookkeeping efforts in the algorithm.

We conclude that both MEDRANK and OMEDRANK are surprisingly fast and scan only an extremely small portion of the database even when MINFREQ is increased to 0.9, which was an unforeseen result. Thus, these algorithms are of particular utility, are very database-friendly, and represent an extremely efficient and effective alternative to L2NN.

Quality

We used two different notions of quality for two different sets of test data. For the first (on stock price history), it is the following. Let q be the query, p be the point in the data set returned by the algorithm (possibly using a projected data) for the query q, and let p* be a point in the data set returned by L2NN on the full dimensional data for the same query q. The quality then is defined to be the ratio d(p, q)/d(p*, q).

In the case of the second (on images of handwritten digits, for which labels were collected), the quality is defined to be the following. Let ε be the classification error of an algorithm (possibly using a projected data) for a set of queries and let ε* be the classification error of L2NN on the full dimension data for the same set of queries. Then, the quality is defined to be the ratio ε/ε*. The main reason for this, rather than presenting the absolute classification error, is that the classification error is not only a function of the nearest neighbor or aggregation algorithm, but also a function of the underlying feature set. We have not attempted to optimize the quality of the underlying features; that is outside the scope of our work. We shall, therefore, restrict ourselves to comparing against the best that a brute-force nearest neighbor algorithm can achieve. Thus both these quantities are defined relative to the performance of L2NN on the full dimension data.

Test results demonstrate that the quality of MEDRANK and OMEDRANK is high. For stock data, the factor of approximation is around 2, meaning that the closest point found by these algorithms is at most factor 2 away from the optimum. Note that L2TA will actually find the nearest neighbor and therefore match the quality of L2NN for that dimension. A more important point to notice is that a factor-2 approximation to the nearest neighbor is found amazingly quickly (often less than 1% of the L2NN running time). The improvements are somewhat less dramatic for the image data: at about 6% of the L2NN running time, we are able to achieve an error that is roughly 5 times more.

Probe Depth

We also studied probe depth and fraction of database accessed. Recall that algorithms L2TA, MEDRANK, and OMEDRANK do not access the complete database in general. For MEDRANK and OMEDRANK which access the database in a database-friendly sequential manner, we record the number of such sequential accesses. In fact, we record the number of such accesses to output each of the top 10 results.

We anticipated the depth of the probe to be correlated with the expected rank of the closest point in the database in each of the m lists. (We talk about the expectation, since the m lists were produced probabilistically.) We computed the distribution of the quantity rank(w), where w is the “winner” for a query q (recall that we consider q as a query for the database D {q}. The distribution was computed by averaging the quantities over 1000 random queries. The expectation of rank(w) (for the stock data) is roughly 0.13, which already means that we can expect MEDRANK and OMEDRANK to never probe more than 13% of the data on the average. The algorithm L2TA in addition to sequential accesses, also makes random accesses. We recorded this information as well. MEDRANK and OMEDRANK access an order of magnitude fewer database elements than L2TA.

Comparing MEDRANK and OMEDRANK, we conclude that in several instances, OMEDRANK offers up to a 20% speed-up over MEDRANK, while preserving the quality of results.

We also conclude that projecting the data into lower dimensions is always an advantageous step, if one only cares about approximate nearest neighbors. While preserving correlations, random projection reduces the effects of noise. On projected data, the quality of these algorithms almost matches that of L2NN on the same data, while the running times are significantly better. Projection also significantly reduces-by at least an order of magnitude-the depth of probes of these algorithms. Therefore, we conclude that while projection is a good idea if one is satisfied with an approximate nearest neighbor, MEDRANK and OMEDRANK are far better alternatives to L2NN (or even L2TA) on the projected data.

We observed that the parameter MINFREQ has a varying role in terms of its significance to MEDRANK and OMEDRANK. For stock data, we note that this parameter plays no significant role, therefore it suffices to keep it low (at 0.5), which yields excellent running times. For the image data, it contributes to lowering the error. However, as one would suspect, it affects the probe depth (and therefore the running time) of these algorithms. Yet, the probe depth still remains one or two orders of magnitude smaller than the size of the database, pointing to the robustness of these algorithms.

We examined how far MEDRANK has to go to uncover each of the top 10 results it produces. There is not much difference between obtaining the top 1 result and the top 10 results. We conclude that L2TA for the nearest neighbor problem offers non-trivial but not a dramatic improvement in speed at lower dimensions, and tends to become poor as the dimension increases. L2TA accesses a constant fraction of the database compared to MEDRANK, which accesses only a tiny fraction.

For MEDRANK, dimension has al most no effect on the probe depth, and even when MINFREQ=0.9, the processing time required is very short. For the image data, the quality of MEDRANK shows much more improvement as a function of dimensionality than the stock data; MINFREQ does not seem to affect the results on stock data very much, but on image data a value of 0.7 seems to be best.

A general purpose computer is programmed according to the inventive steps herein. The invention can also be embodied as an article of manufacture—a machine component—that is used by a digital processing apparatus to execute the present logic. This invention is realized in a critical machine component that causes a digital processing apparatus to perform the inventive method steps herein. The invention may be embodied by a computer program that is executed by a processor within a computer as a series of computer-executable instructions. These instructions may reside, for example, in RAM of a computer or on a hard drive or optical drive of the computer, or the instructions may be stored on a DASD array, magnetic tape, electronic read-only memory, or other appropriate data storage device.

While the particular scheme for EFFICIENT SIMILARITY SEARCH AND CLASSIFICATION VIA RANK AGGREGATION as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for”.

1. A computer-implemented method for automatically determining which objects in a collection best match specified target attribute criteria, the method comprising:
sorting said objects into lists according to individual attribute grades assigned to attributes of said objects;
assigning said objects and a query to points in a multidimensional space;
ranking said objects according to the closeness of each of a number of coordinates in said space to a coordinate corresponding to said query;
aggregating said ranked lists; and
returning the k objects having the highest aggregated ranks, where k is a predetermined number.

2. The method of claim 1 including the further step of:
reducing the number of said coordinates from a number of dimensions d to m=O(ε\hat{ }−2 log n),
where n is the number of said objects and ε is a specified degree of acceptable approximation.

3. The method of claim 1 wherein said ranking step includes:
projecting all the vectors from an origin to said points assigned to said objects onto a random line unique to each said coordinate; and
ranking said objects according to the closeness of said projections to the projection of said query.

4. The method of claim 1 wherein said aggregating includes the further step of:
accessing ranked object lists, one element of every said list at a time, until a particular candidate object appears in more than a specified percentile of all of said lists.

5. The method of claim 4 wherein said specified percentile is the fiftieth percentile so that said aggregated rank is the best median rank.

6. The method of claim 4 wherein not all said ranked lists are accessed to return said objects.

7. The method of claim 4 wherein said accessing excludes random accessing.

8. The method of claim 1 wherein said attributes are categorical and said sorting is according to each said categorical attribute.

9. The method of claim 1 wherein said determining is for at least one of: similarity searching and classification.

10. A computer-implemented method for automatically solving the ε-approximate Euclidean nearest neighbor problem by finding a candidate element in a collection having the best median rank in an election wherein a number of independent voters each rank said candidate elements by proximity to specified target attribute criteria.

11. A general purpose computer system programmed with instructions for automatically determining which objects in a collection best match specified target attribute criteria, the instructions comprising:
sorting said objects into lists according to individual attribute grades assigned to attributes of said objects;
assigning said objects and a query to points in a multidimensional space;
ranking said objects according to the closeness of each of a number of coordinates in said space to a coordinate corresponding to said query;
aggregating said ranked lists; and
returning the k objects having the highest aggregated ranks, where k is a predetermined number.

12. The system of claim 11 including the further instruction of:
reducing the number of said coordinates from a number of dimensions d to m=O(ε\hat{ }−2 log n),
where n is the number of said objects and ε is a specified degree of acceptable approximation.

13. The system of claim 11 wherein said ranking instruction includes instructions for:
projecting all the vectors from an origin to said points assigned to said objects onto a random line unique to each said coordinate; and
ranking said objects according to the closeness of said projections to the projection of said query.

14. The system of claim 11 wherein said aggregating instruction includes the further instruction of:
accessing ranked object lists, one element of every said list at a time, until a particular candidate object appears in more than a specified percentile of all of said lists.

15. The system of claim 14 wherein said specified percentile is the fiftieth percentile so that said aggregated rank is the best median rank.

16. The system of claim 14 wherein not all said ranked lists are accessed to return said objects.

17. The system of claim 14 wherein said accessing excludes random accessing.

18. The system of claim 11 wherein said attributes are categorical and said sorting is according to each said categorical attribute.

19. The system of claim 11 wherein said determining is for at least one of:
similarity searching and classification.

20. A general purpose computer system programmed with instructions to automatically solve the ε-approximate Euclidean nearest neighbor problem by finding a candidate element in a collection having the best median rank in an election wherein a number of independent voters each rank said candidate elements by proximity to specified target attribute criteria.

21. A system for automatically determining which objects in a collection best match specified target attribute criteria, comprising:
means for sorting said objects into lists according to individual attribute grades assigned to attributes of said objects;
means for assigning said objects and a query to points in a multidimensional space;
means for ranking said objects according to the closeness of each of a number of coordinates in said space to a coordinate corresponding to said query;
means for aggregating said ranked lists; and
means for returning the k objects having the highest aggregated ranks, where k is a predetermined number.

22. A computer program product comprising a machine-readable medium having computer-executable program instructions thereon for automatically determining which objects in a collection best match specified target attribute criteria, including:
a first code means for sorting said objects into lists according to individual attribute grades assigned to attributes of said objects;
a second code means for assigning said objects and a query to points in a multidimensional space;
a third code means for ranking said objects according to the closeness of each of a number of coordinates in said space to a coordinate corresponding to said query;
a fourth code means for aggregating said ranked lists; and
a fifth code means for returning the k objects having the highest aggregated ranks, where k is a predetermined number.
